(19) United States
(12) Patent Application Publication
(10) Pub. No.: US 2018/0121858 A1
(43) Pub. Date: May 3, 2018

(54) PERSONALITY ASSESSMENT BASED MATCHING OF SERVICE PERSONNEL

(71) Applicant: INTERNATIONAL BUSINESS MACHINES CORPORATION, Armonk, NY (US)

(72) Inventors: DOUGLAS M. FREIMUTH, NEW YORK, NY (US); BONG JUN KO, HARRINGTON PARK, NJ (US); DINESH C. VERMA, NEW CASTLE, NY (US); SHIQIANG WANG, WHITE PLAINS, NY (US)

(21) Appl. No.: 15/337,432

(22) Filed: Oct. 28, 2016

(51) Int. Cl. G06Q 10/06; G06Q 10/10

(52) U.S. Cl. CPC G06Q 10/063112; G06Q 10/1093

(57) ABSTRACT

Embodiments include methods, systems, and computer program products for scheduling service personnel. Aspects include obtaining observational data for a plurality of service individuals. Aspects also include developing a personality profile for each of the plurality of service individuals based on the observational data. Aspects include receiving a service request from a customer. Then, aspects include obtaining attribute data about the customer to determine one or more inferred personality traits of the customer and analyzing the one or more personality traits of the customer and the personality profile of each of the plurality of service individuals to determine a personality matching score for each of the plurality of service individuals.

### BACKGROUND

The present disclosure relates to personality assessments, and more specifically, to personality assessments based on matching service personnel.

Current mechanisms for personality assessments of employees of an organization consist of questionnaires that are filled out by the employees. These questionnaires are used to determine personality traits of an employee. Some example questionnaires are the Myers Briggs Assessment, the Occupational Interest Inventory, and the DISC (Dominance, Inducement, Submission, and Compliance) Behavior profile. Employees tend to tailor responses to these questionnaires to present the best possible personality for the questionnaire and rarely respond objectively.

Many organizations, including service companies, have their employees interact with customers for service requests. Often, a service request that requires troubleshooting of physical equipment stored in a customer's home or office requires service personnel of a company to physically drive to the customer's home or office to complete the service request. Service personnel are dispatched to the location individually and interact with the customer on a one-on-one basis.

### SUMMARY

Embodiments include a computer implemented method for scheduling service personnel. The method includes obtaining observational data for a plurality of service individuals. The method also includes developing a personality profile for each of the plurality of service individuals based on the observational data. The method further includes receiving a service request from a customer. The method further includes obtaining attribute data about the customer to determine one or more inferred personality traits of the customer and analyzing the one or more personality traits of the customer and the personality profile of each of the plurality of service individuals to determine a personality matching score for each of the plurality of service individuals.

Embodiments include a computer system for scheduling service personnel, the computer system including a server having a processor, the processor configured to perform a method. The method includes obtaining observational data for a plurality of service individuals. The method also includes developing a personality profile for each of the plurality of service individuals based on the observational data. The method further includes receiving a service request from a customer. The method further includes obtaining attribute data about the customer to determine one or more inferred personality traits of the customer and analyzing the one or more personality traits of the customer and the personality profile of each of the plurality of service individuals to determine a personality matching score for each of the plurality of service individuals.

Embodiments also include a computer program product for scheduling service personnel, the computer program product including a non-transitory computer readable storage medium having computer readable program code embodied therewith. The computer readable program code including computer readable program code configured to perform a method. The method includes obtaining observational data for a plurality of service individuals. The method also includes developing a personality profile for each of the plurality of service individuals based on the observational data. The method further includes receiving a service request from a customer. The method further includes obtaining attribute data about the customer to determine one or more inferred personality traits of the customer and analyzing the one or more personality traits of the customer and the personality profile of each of the plurality of service individuals to determine a personality matching score for each of the plurality of service individuals.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 depicts a cloud computing environment according to one or more embodiments of the present invention;

FIG. 2 depicts abstraction model layers according to one or more embodiments of the present invention;

FIG. 3 illustrates a block diagram of a computer system for use in practicing the teachings herein;

FIG. 4 illustrates a block diagram of a system for scheduling service personnel in accordance with one or more embodiments; and

FIG. 5 illustrates a flow diagram of a method for scheduling service personnel in accordance with one or more embodiments.

### DETAILED DESCRIPTION

Current personality assessments utilize questionnaires that can be inaccurate due to the questionnaire taker providing responses that reflect the taker in the best possible way. In these questionnaires, the criteria and questions require subjective answers, which do not allow different personality traits to be based on objective criteria. Additionally, behavior patterns that are indicated by answers to the questionnaire may not accurately reflect the actual behavior of the employee when she or he is working in a service scenario. The current invention approaches a personality assessment in an objective way by analyzing the behavior of an employee in a real-life situation, such as driving a service vehicle.

In order to improve customer satisfaction, the personalities of service personnel need to be matched to the personality of a customer to provide the best experience. Currently, assignment of service personnel takes into account factors such as scheduling constraints and job constraints. Personality assessments are not taken into account when scheduling employee-customer interactions.

In accordance with exemplary embodiments of the disclosure, methods, systems and computer program products for scheduling service personnel based upon personality traits derived from driving data of the service personnel are provided. Service personnel dispatched to service locations of customers spend a significant portion of their work schedule driving in a vehicle. During this time, the service personnel can be observed to determine personality traits and behaviors based upon driving habits and other data taken while the service personnel is driving the vehicle. Driving data can be taken from sensors on a vehicle to determine driving habits such as number of times the driver violates a speed limit or the number of hard brakes the driver performs. Other information such as the speed at which the driver turns on the vehicle from when the driver enters the car can be taken. Or, the tone and intensity of comments made by the driver while operating the vehicle can be taken into consideration as well. This driving data is analyzed to determine a personality profile for the driver (service personnel). Along with driving data, other data such as employee data can be analyzed to further refine the personality profile of the driver. As an example, these other data can include personality questionnaires, demographic data, and customer reviews or complaints.

Once a personality profile is determined for the service individual, the service individual can be match to a service requester (customer) based upon the service individual's personality and inferred personality traits of the customer. The inferred personality traits of the customer can be derived from known demographic data of the customer compared to employee data of the service personnel who share similar demographic data as the customer. Analyzing the personality profile of the service personnel and the inferred personality traits of the customer, a personality matching score can be derived. Based upon the personality matching score, a service individual can be dispatched to the customer location. The service individual would still be constrained by availability and skill set; however, a set of candidates can be determined for service personnel where the highest personality score is dispatched based upon availability and skill set for the service request.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

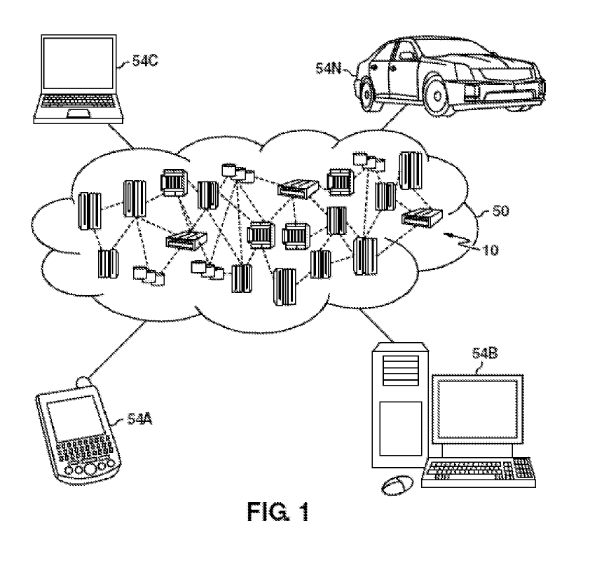

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

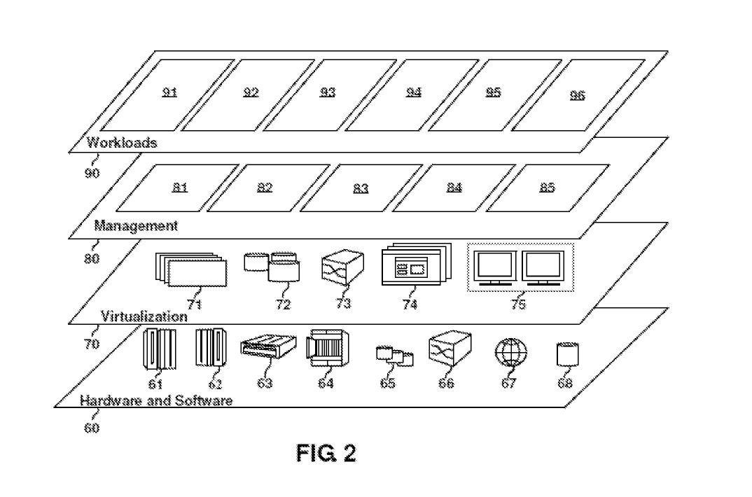

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and scheduling service personnel 96.

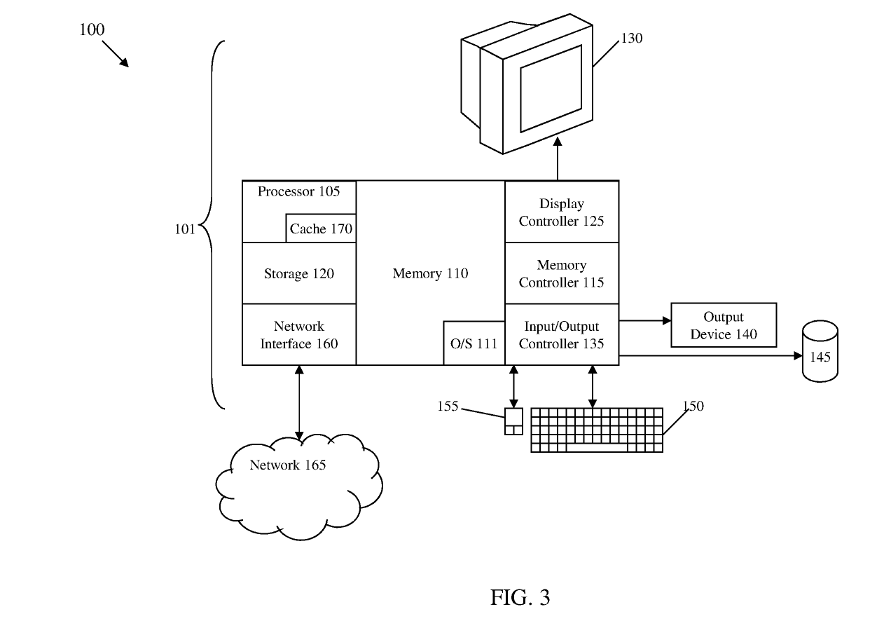

FIG. 3 illustrates a block diagram of an exemplary computer system 100 for use with the teachings herein. The methods described herein can be implemented in hardware software (e.g., firmware), or a combination thereof. In an exemplary embodiment, the methods described herein are implemented in hardware, and is part of the microprocessor of a special or general-purpose digital computer, such as a personal computer, workstation, minicomputer, or mainframe computer. The system 100 therefore includes general-purpose computer 101.

In an exemplary embodiment, in terms of hardware architecture, as shown in FIG. 3, the computer 101 includes a processor 105, memory 110 coupled via a memory controller 115, a storage device 120, and one or more input and/or output (I/O) devices 140, 145 (or peripherals) that are communicatively coupled via a local input/output controller 135. The input/output controller 135 can be, for example, but not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components. The storage device 120 may include one or more hard disk drives (HDD), solid state drives (SSD), or any other suitable form of storage.

The processor 105 is a computing device for executing hardware instructions or software, particularly that stored in memory 110. The processor 105 can be any custom made or commercially available processor, a central processing unit (CPU), an auxiliary processor among several processors associated with the computer 101, a semiconductor based microprocessor (in the form of a microchip or chip set), a macroprocessor, or generally any device for executing instructions. The processor 105 may include a cache 170, which may be organized as a hierarchy of more cache levels (L1, L2, etc.).

The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, and/or other types of storage media. Note that the memory 110 can have a distributed architecture, where various components are situated remote from one another, but can be accessed by the processor 105.

The instructions in memory 110 may include one or more separate programs, each of which comprises an ordered listing of executable instructions for implementing logical functions. In the example of FIG. 3, the instructions in the memory 110 include a suitable operating system (OS) 111. The operating system 111 essentially controls the execution of other computer programs and provides scheduling, input-output control, file and data management, memory management, and communication control and related services.

In an exemplary embodiment, a conventional keyboard 150 and mouse 155 can be coupled to the input/output controller 135. Other output devices such as the I/O devices 140, 145 may include input devices, for example but not limited to a printer, a scanner, microphone, and the like. Finally, the I/O devices 140, 145 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 100 can further include a display controller 125 coupled to a display 130. In an exemplary embodiment, the system 100 can further include a network interface 160 for coupling to a network 165. The network 165 can be an IP-based network for communication between the computer 101 and any external server, client and the like via a broadband connection. The network 165 transmits and receives data between the computer 101 and external systems. In an exemplary embodiment, network 165 can be a managed IP network administered by a service provider. The network 165 may be implemented in a wireless fashion, e.g., using wireless protocols and technologies, such as Wi-Fi, WiMax, etc. The network 165 can also be a packet-switched network such as a local area network, wide area network, metropolitan area network, Internet network, or other similar type of network environment. The network 165 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 101 is a PC, workstation, intelligent device or the like, the instructions in the memory 110 may further include a basic input output system (BIOS) (omitted for simplicity). The BIOS is a set of essential routines that initialize and test hardware at startup, start the OS 111, and support the transfer of data among the storage devices. The BIOS is stored in ROM so that the BIOS can be executed when the computer 101 is activated.

When the computer 101 is in operation, the processor 105 is configured to execute instructions stored within the memory 110, to communicate data to and from the memory 110, and to generally control operations of the computer 101 pursuant to the instructions.

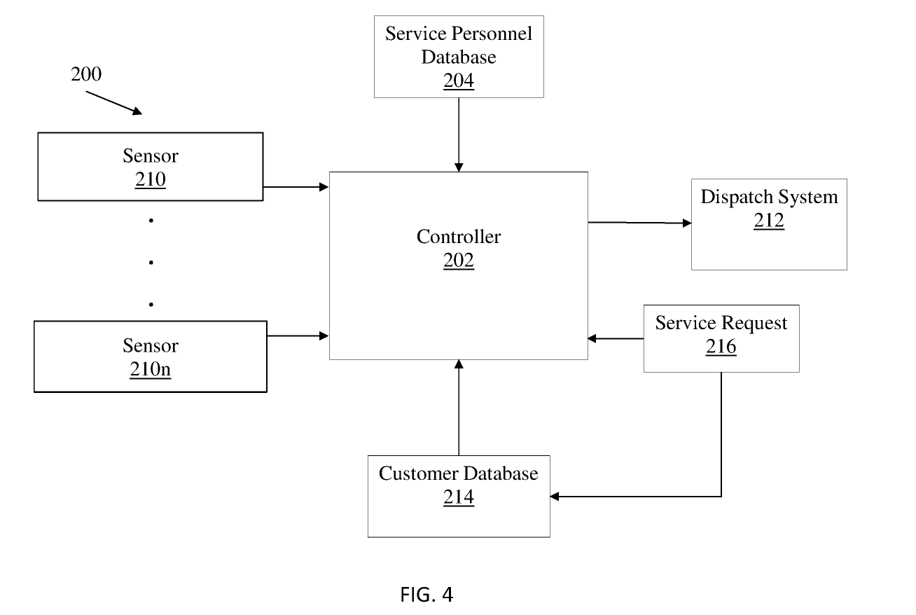

FIG. 4 illustrates a system 200 for scheduling service personnel according to one or more embodiments of the present invention. The system 200 includes a controller 202, a service personnel database 204, one or more sensors 210-210n, a dispatch system 212 and a customer database 214. The system is configured to receive service requests 216 from customers for an organization that requires a potential service visit to a location designated by a customer. For example, a cable provider can receive a service request from a customer when a piece of equipment that delivers cable content to the customer is malfunctioning. A customer can call into the system 200 and request service for this equipment which requires a service individual to drive to and from a customer's home to repair or replace the equipment. The system 200 matches a particular service individual to the customer based upon a personality profile. The personality profile is created by obtaining observational data about the service individual. This observational data includes both employee data about the service individual and driving data obtained about the service individual. The type and method of obtaining this observational data is described below.

The controller 202 can be a part of a larger control system and include a transceiver configured to receive data from the one or more sensors 210-210n. The one or more sensors 210-210n can be directly connected to the controller through an on-board dash (OBD) system attached to a vehicle utilized by service individuals for a company. The one or more sensors 210-210n can be in electronic communication with the controller 202 via local area network, a wide area network, a cellular network, and the like. The one or more sensors 210-210n can include sensors that collect or obtain driving data about the service personnel that includes attributes about the driving behavior of the service personnel. These attributes include the number of speed limit violations over a threshold value, the sharpness of turns made by the vehicle at intersections, the frequency and number of hard brakes, the acceleration and de-acceleration patterns, the tone and intensity of any comments made by the driver while operating the vehicle, the intensity and beats per minute of the music listened to by the driver, and the pace of activities of the driver while in the vehicle (e.g. how quickly and how hard a door is opened and shut, how quickly the car is started after the driver gets in the vehicle, etc.). In order to improve the accuracy and objectivity of the driver profile analysis, the collected sensor data can be combined and analyzed with other contextual information indicating particular circumstances under which the service personnel is operating the vehicle. For example, the traffic pattern on the road map can be combined with the driver's behavior to determine whether the exhibited behavior is under the influence of the current traffic situation, such as unusually high number of brakes due to heavy stop-and-go traffic, hard braking near traffic accidents, etc. The one or more sensors 210-210n can be attached to a smartphone and the driving data is obtained through an application on a smartphone or other smart device in the vehicle.

The obtained driving data is used to determine a personality profile for the service personnel. The driving attributes are used to assess the driver's personality. The assessment can map the driver (service personnel) into one or more classes. For example, an attribute such as number of speeding violations over a certain threshold value can cause the driver to be classified into one of five categories ranging from very safe to very aggressive. The threshold value can be set by a manager to determine the driver personality classification or the threshold value can be determined by historical data across multiple service personnel.

The personality profile developed from the obtained driving data for a service individual can be compared with employee data taken from the service personnel database 204. The service personnel database 204 contains employee data such as demographic data, personality questionnaire data, and historical data for service requests, customer comments and/or complaints, and the like. This employee data can be compared to the personality profile developed from the driving data to reinforce personality attributes or characteristics in the personality profile. The employee data can also be used to soften or lessen the impact of service personality attributes developed from the driving data. For example, a service individual may have been in a stressed state while driving to his or her last few service requests causing certain personality traits to be indicated. Also, employee data such as customer comments that contradict the personality trait can be taken into consideration to soften or lessen an aggressive attribute in a personality profile from the recent driving data.

The controller 202 is configured to receive a service request 216 from a customer. The service request 216 is also sent to the customer database 214. The customer database 214 contains historical data about the customer such as number of service requests made by the customer and any comments or feedback the customer has had about service personnel, as well as customer demographic data (e.g. age, location, income, etc.). The customer demographic data can be compared to data across the service personnel database 204, which can be data-mined to determine general personality characteristics of service personnel sharing the same or similar demographic data. For example, service personnel (employees) data can be data-mined to create a personality rule such as male drivers between the ages of 20 and 30 years old who reside in New York City are aggressive drivers. The personality rule can have an associated probability of accuracy. In the example above, the aggressive driving attribute can be within a probability of 75% or any other probability to show how likely this attribute will be true about people within the same demographic.

The system can determine a personality rule through machine learning and data mining of the service personnel (employee) database 204. In one or more embodiment, the system 200 can employ machine learning algorithms for classification of personality attributes belonging to groups with same or similar demographic information. Machine learning techniques include Random Forests, Decision Tree, Ada boos, Support Vector Machine (SVM), K-Nearest Neighbors, Naïve Bayes, and Neural Networks. In one or more embodiments, the system 200 may employ a greedy-based sequential binary classification model to classify a personality rule for a specific customer group. This model uses the one-against-all decomposition strategy for each binary classification and chooses the best split as the decomposition for that iteration. This is done iteratively until all the classes are classified. In one or more embodiments, the system 200 may employ one or multiple classification models to determine a confidence level of a personality trait associated with one or more demographic groups.

The service request 216 can include customer inputs that could request a service individual with a certain personality profile. For example, for a ride share service request, a customer may request a driver that drives with extreme caution and below the speed limit. The customer could indicate they are not in a rush and could request the driver be cautious while driving. From the driving data obtained from the sensors 210-210n and the service personnel (employee) data, a driver with the requested personality profile is matched up with this customer.

The controller receives data from the one or more sensors 210-210n, the service personnel database 204, the customer database 214 and the dispatch system 212. In one or more embodiments, when a service request 216 is received by the controller 202, the controller obtains driving data, employee data, the personality profile, the customer data, and the personality rules data from the service personnel database 204 to determine a service individual that matches the personality traits of the service requester (i.e. customer). In addition, the dispatch system 212 provides availability data, location data, and other data about the service individual that is utilized to assign or dispatch the service individual to the customer. For example, if a personality profile of a service individual matches a customer personality traits, that service individual is dispatched unless the service individual is unavailable, unqualified to assist, or otherwise unable to reach the customer service request within a time period the customer has identified.

In one or more embodiments, the controller can output a candidate set of service personnel to the dispatch system 212. The candidate set can contain service individuals whose personality profile matches the customer personality traits to a degree above a certain threshold value. The matching of the personalities can be a percentage value such as, for example, a 72% match in personalities. The threshold value can be set such that any personality matches above 50% can be included in the candidate set of service personnel to work on the service request. The threshold value can be set at any value. Alternatively, the candidate set can contain a fixed number of service individuals, selected by their degrees of matching the customer personality traits from the highest to the lowest. The fixed number can be set at any value, for example, the highest being 10 and the lowest being 5. The dispatch system 212 can compare this candidate set to dispatch data to identify the service personnel available at the time of the service request (also, qualified to handle the request) and can take the highest personality match for the available service individuals in the candidate set. When the dispatch system 212 receives the candidate set, the dispatch system 212 can remove service individuals that are unavailable to service the request and output an available candidate set. From the available candidate set, the service individual with the highest personality match with the customer can be dispatched to the location of the service request. Also, the dispatch system 212 or the controller 202 can look at the skill sets of the service individuals in the candidate set to eliminate any service individuals that are unqualified to perform the service request. The dispatch system 212 or controller 202 can develop a skilled candidate set containing a list of service individuals that have a personality match above the set threshold and contain the skills to perform the service request. For example, if a service request requires specific knowledge of a type of equipment, only service individuals with training on that specific equipment type should be dispatched. The member of the skilled candidate set with the highest personality matching score can be dispatched.

Additional customer data can be included in the service request that can override certain personality matching. An example would be the case when a customer requests a specific service individual that the customer has worked with in the past. Or the customer could request a personality trait that does not align with the presumed personality rule of the customer from the service personnel data.

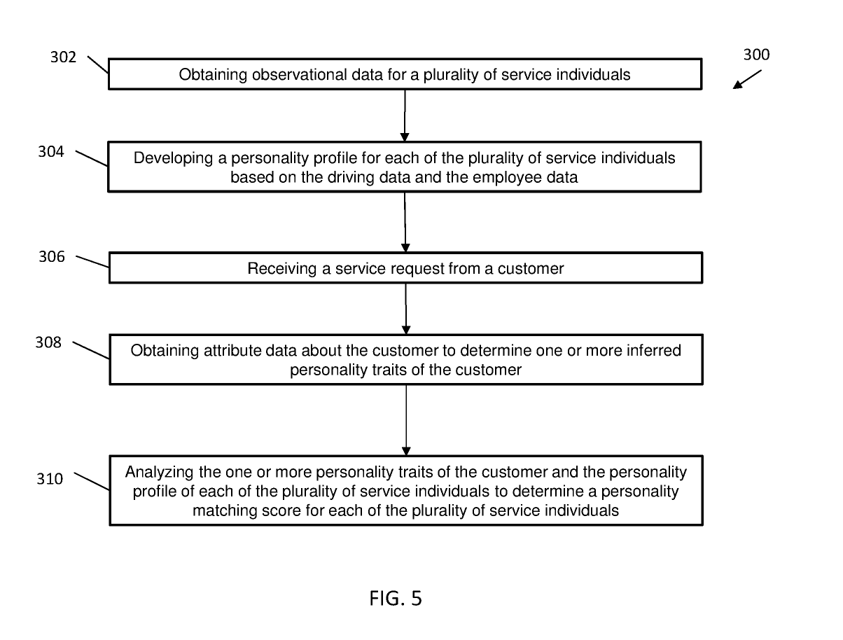

FIG. 5 illustrates a flow diagram of a method 300 for scheduling service personnel according to one or more embodiments. The method 300 includes obtaining observational data for a plurality of service individuals as shown in block 302. Next, at block 304, the method 300 includes developing a personality profile for each of the plurality of service individuals based on the driving data and the employee data. The method 300 includes receiving a service request from a customer as shown at block 306. Next, at block 308, the method 300 includes obtaining attribute data about the customer to determine one or more inferred personality traits of the customer. At block 310, the method 300 includes analyzing the one or more personality traits of the customer and the personality profile of each of the plurality of service individuals to determine a personality matching score for each of the plurality of service individuals.

Additional processes may also be included. It should be understood that the processes depicted in FIG. 5 represent illustrations, and that other processes may be added or existing processes may be removed, modified, or rearranged without departing from the scope and spirit of the present disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting-data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method for scheduling service personnel, the method comprising:
obtaining, by a processor, observational data for a plurality of service individuals, wherein the observational data includes verbal data taken from the service individuals while operating a vehicle;
obtaining, by the processor, employee data for the plurality of service individuals, wherein the employee data includes a personality assessment;
developing a personality profile for each of the plurality of service individuals based on the observational data and the employee data;
receiving a service request from a customer;
obtaining attribute data about the customer to determine one or more inferred personality traits of the customer; and
analyzing the one or more personality traits of the customer and the personality profile of each of the plurality of service individuals to determine a personality matching score for each of the plurality of service individuals.

2. The method of claim 1 further comprising:
determining a candidate set of one or more service individuals from the plurality of service personnel, wherein each of the one or more service individual in the candidate set have a personality matching score above a threshold value.

3. The method of claim 2 further comprising:
dispatching a first service individual from the candidate set to a location of the service request, wherein the personality matching score of the first service individual is a highest personality matching score in the candidate set.

4. The method of claim 2 further comprising:
obtaining a service schedule for each of the one or more service individuals in the candidate set to determine an availability of each of the one or more service individuals in the candidate set;
deriving an available candidate set based upon the availability of the one or more service individuals in the candidate set; and
dispatching a first service individual from the available candidate set to a location of the service request, wherein the personality matching score of the first service individual is a highest personality matching score in the available candidate set.

5. The method of claim 2 further comprising:
obtaining a skill set for each of the one or more service individuals in the candidate set;
comparing the skill set to the service request from the customer;
deriving a skilled candidate set based upon the skill set of each of the one or more service individuals in the candidate set and the service request; and
dispatching a first service individual from the skilled candidate set to a location of the service request, wherein the personality matching score of the first service individual is a highest personality matching score in the skilled candidate set.

6. The method of claim 1, wherein the determining the one or more personality traits of the customer comprises:
analyzing the observational data for the plurality of service individuals to derive one or more personality rules; and
comparing the attribute data about the customer to the one or more personality rules to determine one or more inferred personality traits of the customer.

7. The method of claim 1, wherein the observational data comprises employee data and driving data for each of the plurality of service individuals.

8. The method of claim 7, wherein the employee data comprises at least one of a customer review, an average service time, and a personality questionnaire.

9. The method of claim 1, wherein the one or more personality traits of the customer is input by the customer.

10. A computer system for scheduling service personnel, the computer system including a server having a processor, the processor configured to perform a method comprising:
obtaining observational data for a plurality of service individuals, wherein the observational data includes verbal data taken from the service individuals while operating a vehicle;
obtaining employee data for the plurality of service individuals, wherein the employee data includes a personality assessment;
developing a personality profile for each of the plurality of service individuals based on the observational data and the employee data;
receiving a service request from a customer;
obtaining attribute data about the customer to determine one or more inferred personality traits of the customer; and
analyzing the one or more personality traits of the customer and the personality profile of each of the plurality of service individuals to determine a personality matching score for each of the plurality of service individuals.

11. The system of claim 10 further comprising:
determining a candidate set of one or more service individuals from the plurality of service personnel, wherein each of the one or more service individual in the candidate set have a personality matching score above a threshold value.

12. The system of claim 11 further comprising:
dispatching a first service individual from the candidate set to a location of the service request, wherein the personality matching score of the first service individual is a highest personality matching score in the candidate set.

13. The system of claim 11 further comprising:
obtaining a service schedule for each of the one or more service individuals in the candidate set to determine an availability of each of the one or more service individuals in the candidate set;
deriving an available candidate set based upon the availability of the one or more service individuals in the candidate set; and
dispatching a first service individual from the available candidate set to a location of the service request, wherein the personality matching score of the first service individual is a highest personality matching score in the available candidate set.

14. The system of claim 11 further comprising:
obtaining a skill set for each of the one or more service individuals in the candidate set;
comparing the skill set to the service request from the customer;
deriving a skilled candidate set based upon the skill set of each of the one or more service individuals in the candidate set and the service request; and
dispatching a first service individual from the skilled candidate set to a location of the service request, wherein the personality matching score of the first service individual is a highest personality matching score in the skilled candidate set.

15. The system of claim 10, wherein the determining the one or more personality traits of the customer comprises:
analyzing the observational data for the plurality of service individuals to derive one or more personality rules; and
comparing the attribute data about the customer to the one or more personality rules to determine one or more inferred personality traits of the customer.

16. The system of claim 11, wherein the observational data comprises employee data and driving data for each of the plurality of service individuals.

17. A computer program product for scheduling service personnel, the computer program product comprising a computer readable storage medium having program instructions embodied therewith, the program instructions executable by a processor to cause the processor to perform a method comprising:
obtaining observational data for a plurality of service individuals, wherein the observational data includes verbal data taken from the service individuals while operating a vehicle;
obtaining employee data for the plurality of service individuals, wherein the employee data includes a personality assessment;
developing a personality profile for each of the plurality of service individuals based on the observational data and the employee data;
receiving a service request from a customer;
obtaining attribute data about the customer to determine one or more inferred personality traits of the customer; and
analyzing the one or more personality traits of the customer and the personality profile of each of the plurality of service individuals to determine a personality matching score for each of the plurality of service individuals.

18. The computer program product of claim 17 further comprising:
determining a candidate set of one or more service individuals from the plurality of service personnel, wherein each of the one or more service individual in the candidate set have a personality matching score above a threshold value.

19. The computer program product of claim 18 further comprising:
dispatching a first service individual from the candidate set to a location of the service request, wherein the personality matching score of the first service individual is a highest personality matching score in the candidate set.

20. The computer program product of claim 17, wherein the observational data comprises employee data and driving data for each of the plurality of service individuals.
